(19) United States
(12) Patent Application Publication
(10) Pub. No.: US 2024/0126987 A1
(43) Pub. Date: Apr. 18, 2024

(54) DECISION MAKING AS LANGUAGE GENERATION

(71) Applicant: QUALCOMM Incorporated, San Diego, CA (US)

(72) Inventors: Roland MEMISEVIC, Toronto (CA); Mingu LEE, San Diego, CA (US); Sunny Praful Kumar PANCHAL, Toronto (CA)

(21) Appl. No.: 18/477,515

(22) Filed: Sep. 28, 2023

Related U.S. Application Data
(60) Provisional application No. 63/412,773, filed on Oct. 3, 2022.

(51) Int. Cl. G06F 40/20

(52) U.S. Cl. CPC G06F 40/20

(57) ABSTRACT

A processor-implemented method includes receiving an input comprising a previous language stream, and generating an output language stream by a pre-trained language model, based on the input. The method further includes detecting a well-formed action based on patterns in the output language stream, and performing an operation, by an environment, in response to detecting the well-formed action. The operation returns a result. The method also includes appending the result to the output language stream to obtain an updated output language stream. The method includes repeating the generating, with the updated output language stream as the input, the detecting, the performing, and the appending until a termination condition is satisfied.

### CROSS-REFERENCE TO RELATED APPLICATION

The present application claims the benefit of U.S. Provisional Patent Application No. 63/412,773, filed on Oct. 3, 2022, and titled “DECISION MAKING AS LANGUAGE GENERATION,” the disclosure of which is expressly incorporated by reference in its entirety.

### FIELD OF THE DISCLOSURE

Aspects of the present disclosure generally relate to artificial neural networks, and more specifically to training language models to make decisions by treating decisions as language.

### BACKGROUND

Artificial neural networks may comprise interconnected groups of artificial neurons (e.g., neuron models). The artificial neural network may be a computational device or be represented as a method to be performed by a computational device. In particular, these neural network architectures are used in various technologies, such as image recognition, speech recognition, acoustic scene classification, keyword spotting, autonomous driving, and other classification tasks. It would be desirable to use pre-trained language models for applications beyond speech recognition or keyword spotting.

Auto-regressive language models are increasingly used to perform computations that traditionally run on classic computer hardware such as a central processing unit (CPU). Auto-regressive language models may interact with classic software by emitting special tokens that a supervising script can interpret as “commands.”

However, conventional approaches utilize specialized architectures, where dedicated action heads emit such special tokens. As a result, it is challenging to pre-train the specialized model on, or regularize for, natural language processing (NLP) tasks. Moreover, the model may not be trained concurrently with multiple additional tasks.

### SUMMARY

In aspects of the present disclosure, a processor-implemented method includes receiving an input comprising a previous language stream. The method also includes generating an output language stream by a pre-trained language model, based on the input. The method further includes detecting a well-formed action based on patterns in the output language stream. The method also includes performing an operation, by an environment, in response to detecting the well-formed action, the operation returning a result. The method also includes appending the result to the output language stream to obtain an updated output language stream. The method includes repeating the generating, with the updated output language stream as the input, the detecting, the performing, and the appending until a termination condition is satisfied.

Other aspects of the present disclosure are directed to an apparatus. The apparatus has at least one memory and one or more processors coupled to the memory. The processor(s) is configured to receive an input comprising a previous language stream. The processor(s) is also configured to generate an output language stream by a pre-trained language model, based on the input. The processor(s) is configured to detect a well-formed action based on patterns in the output language stream. The processor(s) is also configured to perform an operation, by an environment, in response to detecting the well-formed action, the operation returning a result. The processor(s) is configured to append the result to the output language stream to obtain an updated output language stream. The processor(s) is configured to repeat generating, with the updated output language stream as the input, detecting, performing, and appending until a termination condition is satisfied.

Other aspects of the present disclosure are directed to an apparatus. The apparatus includes means for receiving an input comprising a previous language stream and means for generating an output language stream by a pre-trained language model, based on the input. The apparatus further includes means for detecting a well-formed action based on patterns in the output language stream and means for performing an operation, by an environment, in response to detecting the well-formed action, the operation returning a result. The apparatus includes means for appending the result to the output language stream to obtain an updated output language stream. The apparatus also includes means for repeating the generating, with the updated output language stream as the input, the detecting, the performing, and the appending until a termination condition is satisfied.

In other aspects of the present disclosure, a non-transitory computer-readable medium with program code recorded thereon is disclosed. The program code is executed by a processor and includes program code to receive an input comprising a previous language stream. The program code also includes program code to generate an output language stream by a pre-trained language model, based on the input, and program code to detect a well-formed action based on patterns in the output language stream. The program code also includes program code to perform an operation, by an environment, in response to detecting the well-formed action, the operation returning a result, and program code to append the result to the output language stream to obtain an updated output language stream. The program code also includes program code to repeat the generating, with the updated output language stream as the input, the detecting, the performing, and the appending until a termination condition is satisfied.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIG. 2 is a block diagram illustrating an example transformer architecture in accordance with various aspects of the present disclosure.

FIG. 3 is a flow diagram illustrating a processor-implemented method for decision making based on results obtained from a pre-trained language model, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, auto-regressive sequence models may perform computations that traditionally run on classic computer hardware, e.g., central processing units (CPUs). Auto-regressive sequence models may be used as a policy in a reinforcement learning problem by training the model to generate (state, action, return)-triplets. Auto-regressive sequence models may also generate language and perform reasoning by using the language. Conventional models trained as a policy have been based on specialized architectures, by using state/action/reward-specific prediction heads, which may preclude the conventional models from leveraging language in the decision making process. Similarly, the specialized architectures may preclude decision making capabilities of the network to be brought to bear in language generation and reasoning tasks.

Decision transformers are a recently proposed approach to offline reinforcement learning (RL). Reinforcement learning is a machine learning technique that enables an agent to learn in an interactive environment using feedback from the agent actions. A reward signal may encourage or discourage certain actions or behavior. One goal in reinforcement learning is to determine actions that increase, or possibly maximize, a total cumulative reward.

Decision transformers may define a policy in an offline reinforcement learning task as a transformer-based, auto-regressive sequence model. Decision transformers may be trained and supervised on sequences of triplets of actions, states, and returns (e.g., total cumulative rewards) from roll-outs of an expert or other (including random) policy. Prompting with a high return at test-time may encourage a decision transformer to follow action trajectories associated with high rewards and may perform well.

Although decision transformers may be a successful approach to offline RL, applications of such conventional decision transformers may come with a significant shortcoming. That is, the conventional decision transformers may be conceived of as RL-specific architectures, with task-specific action-, state- and reward-heads. Furthermore, the conventional decision transformers may often be trained on a narrowly defined set of target tasks.

Additional challenges may include difficulty associated with fine-tuning a pre-trained language model on a decision making task. Aspects of the present disclosure propose solutions to these challenges and consider their viability on a shortest path problem. Further aspects of the present disclosure utilize data-centric approaches to improve language models and open up the possibility to treat the decision transformer objective as one task alongside others to perform transfer learning.

Aspects of the present disclosure are directed to an artificial neural network (ANN) model that combines language modeling and decision making within a single model. At inference time, an environment may repeatedly execute the ANN model to incrementally generate an output sequence. The environment may also monitor the output generated by the ANN model to detect an occurrence of any well-formed actions. When a well-formed action is detected, the environment may perform an operation, and return a result. The result may be written back into the language stream generated by the ANN model.

Further aspects of the present disclosure may perform training on proper sub-sequences of the training sequences to enable tokens of the ANN model to be presented for training in isolation. In other words, each token may be presented without being prepended by or succeeded by another token.

Still other aspects are directed to pre-processing training data for the ANN model, such that initial rewards may be replaced by higher reward values. The pre-processing may train the ANN model to interpret the initial reward information as a reward value to approximate, rather than as a reward value to perfectly replicate (as is the case in some conventional approaches).

Particular aspects of the subject matter described in the present disclosure may be implemented to achieve one or more of the following potential advantages. In some examples, the described techniques, such as generating an output language stream, detecting a well-formed action, performing an operation, and appending the result may allow practitioners to treat a decision making task differently from an isolated task. The described techniques also make it possible to train more general multi-task models and exploit synergies between tasks.

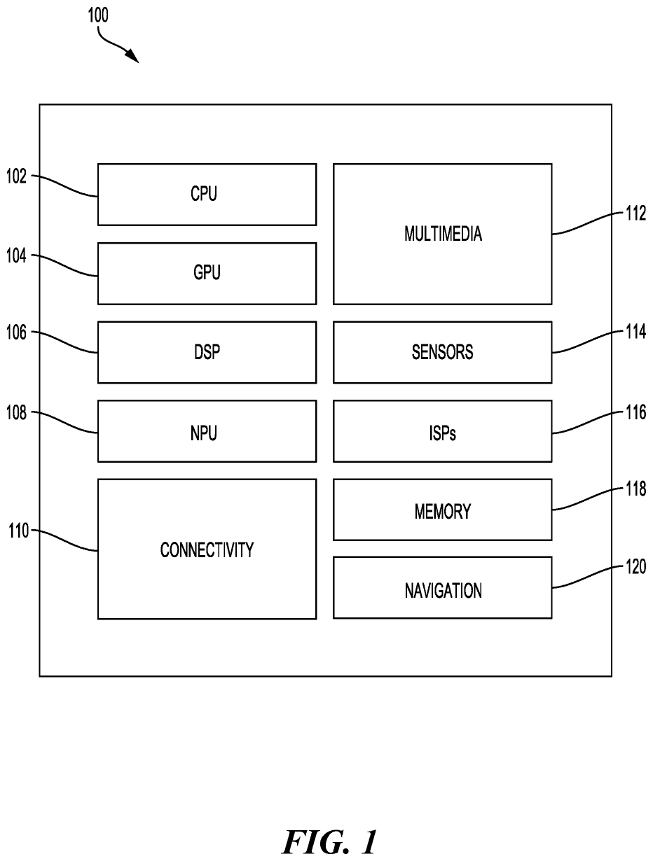

FIG. 1 illustrates an example implementation of a system-on-a-chip (SOC) 100, which may include a central processing unit (CPU) 102 or a multi-core CPU configured for decision making based on language models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to receive an input comprising a previous language stream, and code to generate an output language stream by a pre-trained language model, based on the input. The general-purpose processor 102 may further include code to detect a well-formed action based on patterns in the output language stream, and code to perform an operation, by an environment, in response to detecting the well-formed action, the operation returning a result. The general-purpose processor 102 may also include code to append the result to the output language stream to obtain an updated output language stream. The general-purpose processor 102 may also include code to repeat the code to generate, with the updated output language stream as the input, the code to detect, the code to perform, and the code to append until a termination condition is satisfied.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map receiving input from a range of neurons in the previous layer and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

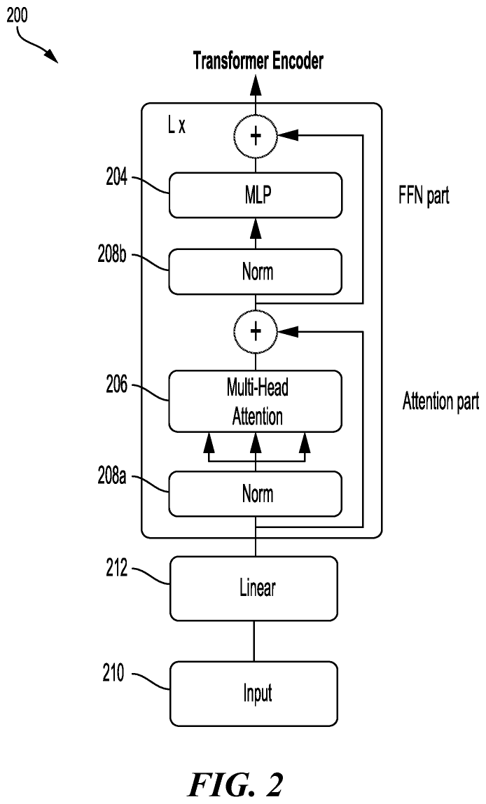

FIG. 2 is a block diagram illustrating an example transformer architecture 200. The example transformer architecture 200 may include alternating layers of attention blocks 206 and MLP blocks 204. A layer norm block 208 (e.g., 208a, 208b) may be applied before every block of the transformer architecture 200. The attention blocks 206 and MLP blocks 204 may each include a residual connection.

The example transformer architecture 200 may receive an input such as sequential data 210. In some examples, the sequential data 210 may include (but is not limited to) a sequence of characters or textual data (e.g., a sentence) or audio data, for instance. The transformer architecture 200 may divide the input 210 into portions or tokens (e.g., words).

The tokens may be further processed for example, via a linear layer 212, which generates a sequence of linear embeddings. In some aspects, positional embeddings may be added to the linear embeddings to tokens with positional embeddings. The linear embeddings may be normalized via layer norm block 208 and provided to the attention block 206.

The attention block 206 may implement self-attention or multi-head attention to determine relationships among the embeddings for each token. That is, the attention block 206 may assign different attention weights to different portions of the sequence of embeddings corresponding to the tokens. The output of the attention block 206 may be provided to the MLP block 204 and processed to generate an output inference such as a classification, for example.

As described, aspects of the present disclosure are directed to an artificial neural network (ANN) model that combines language modeling and decision making within a single model. The ANN model may comprise (but is not limited to) a decision transformer model that treats the model as a pure language model, for example. The ANN model may be pre-trained and/or regularized for natural language processing (NLP) tasks, while fine-tuning the ANN model on the task-specific reinforcement learning (RL) objective.

NLP combines computational linguistics and machine learning to process human languages. NLP may aim to process natural language datasets such as text corpora or speech corpora using rule-based or probabilistic machine learning. As such, the focus in RL tasks may shift away from architecture search toward data-centric development. As an application of this data-centric view, the notorious problem of reward-mismatch may be addressed. The reward-mismatch problem involves the circumstance where in many decision making tasks, the achievable return for an episode cannot be known ahead of generating the roll-out of the policy at run-time. Thus, it may not be possible to know an appropriate return with which to prompt the ANN model.

Aspects of the present disclosure may address the reward-mismatch problem with a data pre-processing step that biases the ANN model toward attempting to approximate the achievable return, thereby enabling an improved, and in some aspects, a near-optimal performance, by always prompting with a higher desired reward and enabling the ANN model to correct to a highest achievable reward.

The decision making task may be considered as a task of modeling sequences of triplets (a, s, r), based on training data {(aₜⁱ,sₜⁱ,rₜⁱ)}ᵢ₌₁^{N} where aₜⁱ is an observed action at time t, sₜⁱ is an observed state at time t, and rₜⁱ is the cumulative return (or “return-to-go”) that the given training trajectory incurred from time t onward. At inference time, an agent may be prompted with a start state s and desired return r and may generate an action a (followed by further states, returns, and actions). In an example, the agent may be a robot operating in an environment comprising a labyrinth. In the example, the objective may be to find a shortest path to navigate to a target location (e.g., a center or an exit) of the labyrinth. With each action (e.g., a move) taken by the robot through the labyrinth, the state (e.g., location of the robot) may be observed and a reward may be determined (e.g., +1 if closer to the target, or −1 if farther from the target, or each move may result in a reward of −1).

To enable the pre-training of the language model for performing decision making tasks, a tokenizer and vocabulary may be determined to express actions, states, and returns as “language.” The encoding of actions, states, and returns may be limited to encodings that can be detected by a regular expression. A regular expression refers to a sequence of characters that specify a match pattern in text. For instance, the encoding technique may include (but is not limited to) white-space separated values, extensible markup language (XML)-notation (e.g., “ [symbol] s [symbol] 3 [symbol] /s [symbol] [symbol] r [symbol] 5 [symbol] /r [symbol] [symbol] a [symbol] . . . ”), or the like. In various aspects, the encoding technique may include a comma-separated notation (e.g., “s=3, r=5, a= . . . ”), for instance. The encoding technique may beneficially enable interleaving data from other tasks, including simple language, with the task-specific data.

An environment may be modeled as a Markov decision process (MDP), for example. A Markov decision process refers to a stochastic control process that uses a mathematical framework to model the decision making of a dynamic system, in which the outcome may be random or controlled at least in part by a decision maker.

In various aspects of the present disclosure, the decision-making task may be solely absorbed within the language modeling objective rather than solving the decision-making task using a specialized architecture. Therefore, unlike conventional approaches, the ANN model architecture disclosed may not have any task-specific heads, any task-specific tokens, or word embeddings.

At inference time, an environment may repeatedly execute the ANN model to incrementally generate an output sequence. In the absence of a task-specific output, the environment may continuously monitor and parse the ANN model output to detect an occurrence of well-formed actions within the ANN model output stream. For example, a well-formed action may be detected if a regular expression matches an action output.

When a well-formed action is detected, the environment (or an agent within the environment) may perform an operation, such as a state transition, and return a result, such as a new state and/or reward. The result may be written back into the output stream generated by the ANN model. The process may be repeated with the updated input, until a termination condition is satisfied.

To use a general-purpose language model for decision-making tasks, the tokenizer of the general-purpose language model may be used. As a result, an output sequence generated by the general-purpose language model may not advance one character at a time. For example, auto-regressive language models may be trained using sub-word representations, such as byte-pair encoding, in which case a single model inference may generate multiple characters rather than a single character. This is because the general-purpose language model may generate one “token” at a time where a token is a single unit of it's vocabulary. Each token may represent multiple characters. Thus, the general-purpose language model may be configured to generate a token which includes a grouping of multiple characters. For increased flexibility, the environment may interact with the ANN model on the character level instead.

Accordingly, in various aspects of the present disclosure, the environment may continuously monitor the ANN model output by maintaining (i) a buffer of characters emitted (e.g., output) by the ANN model and (ii) a pointer that indicates an end of the preceding well-formed action detected. Each emission by the ANN model may be parsed using the regular expression, and the pointer may be updated, if applicable. When a well-formed action is detected, the environment may generate a state and a reward, which may be encoded and appended to the ANN model output stream according to the position of the pointer. That is, the pointer may be moved to the position immediately after the matched pattern. For example, if a designed pattern is “a=6”, the pointer may be moved to the position of the delimiter “,” for instance. If the pattern is inclusive of the delimiter (e.g., the matched pattern is “a=6,”), then the pointer may be moved to a position immediately following the delimiter.

The character sequences at the transitions between ANN model output and environment output (e.g., state and/or reward) may not include token sequences that are common (or even included at all) in the pre-training or fine-tuning dataset. As such, the pre-trained model may be unable to generate reasonable decision sequences and may be referred to as a form of exposure bias. Exposure bias may occur, for example at inference time, when the model observes token sequences that are rarely or never observed during training, causing the model to behave in unpredictable ways.

To address the exposure bias issue for fine-tuning the model on decision sequences, the training dataset may be populated with randomly generated crops of proper sub-sequences as a pre-processing step. The crops may be generated at the character level to increase the likelihood, and in some aspects ensure, that each character occurs as the first or last character in a sequence and exposes the model to every character sequence that environment forcing may generate at inference time. In other words, each token may be presented without being prepended by or succeeded by another token. Thus, by performing the pre-processing, the ANN model may be enabled to operate in a more predictable manner.

In some aspects, the training data for the ANN model may also be pre-processed such that initial rewards are replaced by higher reward values. The pre-processing may train the ANN model to interpret the initial reward information as a reward value to approximate, rather than as a reward value to perfectly replicate. For example, if an ideal reward is a ten on a scale of one to ten, the pre-processing may convert a reward value of five to a reward value that falls between five and ten. The new value may be deterministically calculated, for example. The pre-processing may enable configuring the ANN model at inference time without knowing the achievable reward ahead of time by starting the language generation with a high reward value. Moreover, the use of stochastic solutions, which are based on sampling and priors, to encourage higher rewards, may be limited.

In some aspects, multiple environments may be used. For instance, the actions may comprise application programming interfaces (API) calls, for instance to a web server. Each of the environments may write back to a shared buffer. In turn, the ANN model may determine an action to be performed in each of the multiple environments.

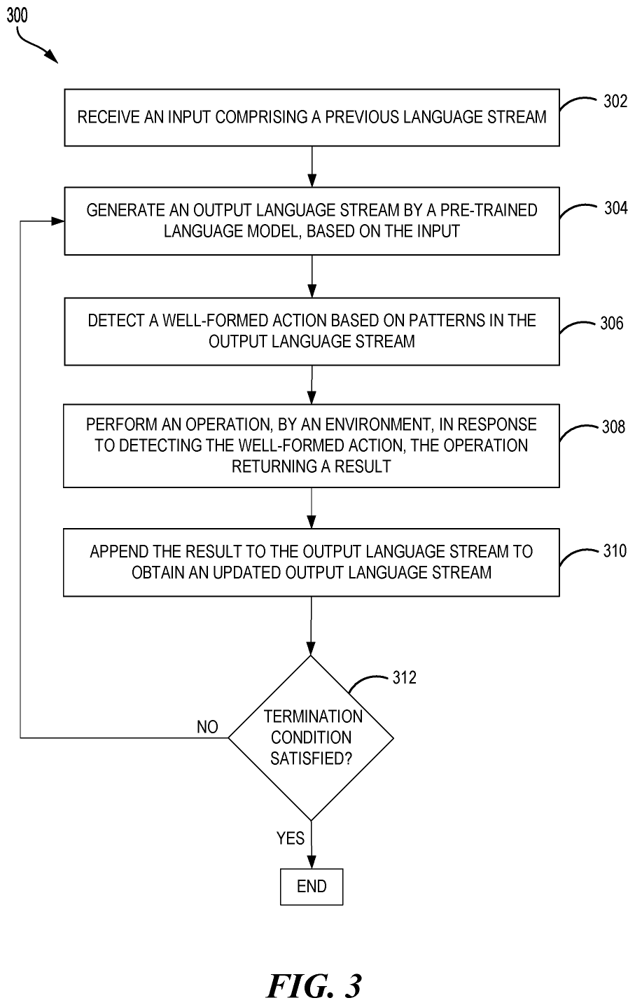

FIG. 3 is a flow diagram illustrating a processor-implemented method 300 for decision making based on results obtained from a pre-trained language model, in accordance with various aspects of the present disclosure. The processor-implemented method 300 may be performed by one or more processors, such as the CPU (e.g., 102), GPU (e.g., 104), DSP (e.g., 106), and/or NPU (e.g., 108), for example.

As shown in FIG. 3, in some aspects, at block 302, the processor may receive an input comprising a previous language stream. For instance, the previous language stream may be an observed state and a reward corresponding to a previous action taken by an agent in an environment.

At block 304, the processor may generate an output language stream by a pre-trained language model, based on the input. For instance, the output language stream may generate a set of characters to indicate an action. The characters may include (but are not limited to) a letter, symbols (e.g., a comma or an equal sign (=)), or a space.

At block 306, the processor may detect a well-formed action based on patterns in the output language stream. For example, the detecting may be achieved by parsing a regular expression. For instance, a well-formed action may be in the form of comma separated notation, and as such, an action followed by a comma may represent a well-formed action.

At block 308, the processor may perform an operation, by an environment, in response to detecting the well-formed action. The operation returns a result. For example, the operation may be a state transition in the environment, such that the result includes a new state and/or a reward. As described, for instance, when a well-formed action is detected, the environment may generate a state and a reward.

At block 310, the processor may append the result to the output language stream to obtain an updated output language stream. For instance, as described, the state and reward generated by the environment may be encoded and appended to the ANN model output stream according to the position of the pointer.

At block 312, the processor may determine if a termination condition is satisfied. If the termination condition is not satisfied (block 312: NO), then the processor-implemented method 300 may return to the generating step (block 304), with the updated output language stream as the input. If the termination condition is satisfied (block 312: YES), then the processor-implemented method 300 ends.

### EXAMPLE ASPECTS

Aspect 1: A processor-implemented method comprising: receiving an input comprising a previous language stream; generating an output language stream by a pre-trained language model, based on the input; detecting a well-formed action based on patterns in the output language stream; performing an operation, by an environment, in response to detecting the well-formed action, the operation returning a result; appending the result to the output language stream to obtain an updated output language stream; and repeating the generating, with the updated output language stream as the input, the detecting, the performing, and the appending until a termination condition is satisfied.

Aspect 2: The processor-implemented method of Aspect 1, in which the operation is a state transition in the environment, and the result includes a new state and/or a reward.

Aspect 3: The processor-implemented method of Aspect 1 or 2, in which training data comprises randomly generated crops of sub-sequences.

Aspect 4: The processor-implemented method of any of the preceding Aspects, further comprising detecting by parsing using a pointer to indicate an end of a last well-formed action.

Aspect 5: The processor-implemented method of any of the preceding Aspects, in which the last well-formed action is included in a regular expression.

Aspect 6: The processor-implemented method of any of the preceding Aspects, further comprising pre-processing training data, prior to training, to replace a first return encoding with a random value.

Aspect 7: An apparatus, comprising: at least one memory; and at least one processor coupled to the at least one memory, the at least one processor configured to: receive an input comprising a previous language stream; generate an output language stream by a pre-trained language model, based on the input; detect a well-formed action based on patterns in the output language stream; perform an operation, by an environment, in response to detecting the well-formed action, the operation returning a result; append the result to the output language stream to obtain an updated output language stream; and repeat generating, with the updated output language stream as the input, detecting, performing, and appending until a termination condition is satisfied.

Aspect 8: The apparatus of Aspect 7, in which the operation is a state transition in the environment, and the result includes a new state and/or a reward.

Aspect 9: The apparatus of Aspect 7 or 8, in which training data comprises randomly generated crops of sub-sequences.

Aspect 10: The apparatus of any of the Aspects 7-9, in which the at least one processor is further configured to detect by parsing using a pointer to indicate an end of a last well-formed action.

Aspect 11: The apparatus of any of the Aspects 7-10, in which the last well-formed action is included in a regular expression.

Aspect 12: The apparatus of any of the Aspects 7-11, in which the at least one processor is further configured pre-process training data, prior to training, to replace a first return encoding with a random value.

Aspect 13: An apparatus, comprising: means for receiving an input comprising a previous language stream; means for generating an output language stream by a pre-trained language model, based on the input; means for detecting a well-formed action based on patterns in the output language stream; means for performing an operation, by an environment, in response to detecting the well-formed action, the operation returning a result; means for appending the result to the output language stream to obtain an updated output language stream; and means for repeating the generating, with the updated output language stream as the input, the detecting, the performing, and the appending until a termination condition is satisfied.

Aspect 14: The apparatus of Aspect 13, in which the operation is a state transition in the environment, and the result includes a new state and/or a reward.

Aspect 15: The apparatus of Aspect 13 or 14, in which training data comprises randomly generated crops of sub-sequences.

Aspect 16: The apparatus of any of the Aspects 13-15, further comprising means for detecting by parsing using a pointer to indicate an end of a last well-formed action.

Aspect 17: The apparatus of any of the Aspects 13-16, in which the last well-formed action is included in a regular expression.

Aspect 18: The apparatus of any of the Aspects 13-17, further comprising means for pre-processing training data, prior to training, to replace a first return encoding with a random value.

Aspect 19: A non-transitory computer-readable medium having program code recorded thereon, the program code executed by a processor and comprising: program code to receive an input comprising a previous language stream; program code to generate an output language stream by a pre-trained language model, based on the input; program code to detect a well-formed action based on patterns in the output language stream; program code to perform an operation, by an environment, in response to detecting the well-formed action, the operation returning a result; program code to append the result to the output language stream to obtain an updated output language stream; and program code to repeat the generating, with the updated output language stream as the input, the detecting, the performing, and the appending until a termination condition is satisfied.

Aspect 20: The non-transitory computer-readable medium of Aspect 19, in which the operation is a state transition in the environment, and the result includes a new state and/or a reward.

Aspect 21: The non-transitory computer-readable medium of Aspect 19 or 20, in which the training data comprises randomly generated crops of sub-sequences.

Aspect 22: The non-transitory computer-readable medium of any of the Aspects 19-21, in which the program code further comprises program code to detect by parsing using a pointer to indicate an end of a last well-formed action.

Aspect 23: The non-transitory computer-readable medium of any of the Aspects 19-22, in which the last well-formed action is included in a regular expression.

Aspect 24: The non-transitory computer-readable medium of any of the Aspects 19-23, in which the program code further comprises program code to pre-process training data, prior to training, to replace a first return encoding with a random value.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving an input comprising a previous language stream;
generating an output language stream by a pre-trained language model, based on the input;
detecting a well-formed action based on patterns in the output language stream;
performing an operation, by an environment, in response to detecting the well-formed action, the operation returning a result;
appending the result to the output language stream to obtain an updated output language stream; and
repeating the generating, with the updated output language stream as the input, the detecting, the performing, and the appending until a termination condition is satisfied.

2. The processor-implemented method of claim 1, wherein the operation is a state transition in the environment, and the result includes a new state and/or a reward.

3. The processor-implemented method of claim 1, wherein training data comprises randomly generated crops of sub-sequences.

4. The processor-implemented method of claim 1, further comprising detecting by parsing using a pointer to indicate an end of a last well-formed action.

5. The processor-implemented method of claim 4, wherein the last well-formed action is included in a regular expression.

6. The processor-implemented method of claim 1, further comprising pre-processing training data, prior to training, to replace a first return encoding with a random value.

7. An apparatus, comprising:
at least one memory; and
at least one processor coupled to the at least one memory, the at least one processor configured to:
receive an input comprising a previous language stream;
generate an output language stream by a pre-trained language model, based on the input;
detect a well-formed action based on patterns in the output language stream;
perform an operation, by an environment, in response to detecting the well-formed action, the operation returning a result;
append the result to the output language stream to obtain an updated output language stream; and
repeat generating, with the updated output language stream as the input, detecting, performing, and appending until a termination condition is satisfied.

8. The apparatus of claim 7, wherein the operation is a state transition in the environment, and the result includes a new state and/or a reward.

9. The apparatus of claim 7, wherein training data comprises randomly generated crops of sub-sequences.

10. The apparatus of claim 7, wherein the at least one processor is further configured to detect by parsing using a pointer to indicate an end of a last well-formed action.

11. The apparatus of claim 10, wherein the last well-formed action is included in a regular expression.

12. The apparatus of claim 7, wherein the at least one processor is further configured pre-process training data, prior to training, to replace a first return encoding with a random value.

13. An apparatus, comprising:
means for receiving an input comprising a previous language stream;
means for generating an output language stream by a pre-trained language model, based on the input;
means for detecting a well-formed action based on patterns in the output language stream;
means for performing an operation, by an environment, in response to detecting the well-formed action, the operation returning a result;
means for appending the result to the output language stream to obtain an updated output language stream; and
means for repeating the generating, with the updated output language stream as the input, the detecting, the performing, and the appending until a termination condition is satisfied.

14. The apparatus of claim 13, wherein the operation is a state transition in the environment, and the result includes a new state and/or a reward.

15. The apparatus of claim 13, wherein training data comprises randomly generated crops of sub-sequences.

16. The apparatus of claim 13, further comprising means for detecting by parsing using a pointer to indicate an end of a last well-formed action.

17. The apparatus of claim 16, wherein the last well-formed action is included in a regular expression.

18. The apparatus of claim 13, further comprising means for pre-processing training data, prior to training, to replace a first return encoding with a random value.

19. A non-transitory computer-readable medium having program code recorded thereon, the program code executed by a processor and comprising:
program code to receive an input comprising a previous language stream;
program code to generate an output language stream by a pre-trained language model, based on the input;
program code to detect a well-formed action based on patterns in the output language stream;
program code to perform an operation, by an environment, in response to detecting the well-formed action, the operation returning a result;
program code to append the result to the output language stream to obtain an updated output language stream; and
program code to repeat the generating, with the updated output language stream as the input, the detecting, the performing, and the appending until a termination condition is satisfied.

20. The non-transitory computer-readable medium of claim 19, wherein the operation is a state transition in the environment, and the result includes a new state and/or a reward.

21. The non-transitory computer-readable medium of claim 19, wherein training data comprises randomly generated crops of sub-sequences.

22. The non-transitory computer-readable medium of claim 19, wherein the program code further comprises program code to detect by parsing using a pointer to indicate an end of a last well-formed action.

23. The non-transitory computer-readable medium of claim 22, wherein the last well-formed action is included in a regular expression.

24. The non-transitory computer-readable medium of claim 19, wherein the program code further comprises program code to pre-process training data, prior to training, to replace a first return encoding with a random value.
